(19) United States
(12) Patent Application Publication
(10) Pub. No.: US 2013/0214661 A1
(43) Pub. Date: Aug. 22, 2013

(54) Folding Tablet Keyboard Case

(71) Applicant: Brian Dale McBroom, Frisco, TX (US)

(72) Inventor: Brian Dale McBroom, Frisco, TX (US)

(21) Appl. No.: 13/774,411

(22) Filed: Feb. 22, 2013

Related U.S. Application Data
(60) Provisional application No. 61/601,999, filed on Feb. 22, 2012.

(51) Int. Cl. G06F 1/16

(52) U.S. Cl. CPC G06F 1/1667; G06F 1/1666
USPC 312/325; 312/223.2

(57) ABSTRACT

A folding tablet keyboard case comprising a tablet cover having exterior and interior sides with circumferential edges, a keyboard cover having exterior and interior sides cover with circumferential edges and, and a spine including at least one or more folding hinges, where the spine connects the tablet cover and the keyboard cover and wherein a portion of the spine comprises a portion of the keyboard cover. The tablet keyboard case provides for at least four general configurations that provide for a streamlined form factor in the open tablet position, closed tablet position, open keyboard position and tilted tablet position. The tablet keyboard case uses reusable fasteners to detachably secure the tablet keyboard case in the desired configuration.

### CROSS-REFERENCE TO RELATED APPLICATIONS

This application claims the benefit of provisional Application No. 61/601,999 filed Feb. 22, 2012, the disclosure of which is incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to a folding cover or case for electronic laptop and tablet computing and keyboard devices, such as the iPad manufactured by Apple and the Galaxy tablet manufactured by Samsung among others, and smartphone devices, such as the Apple iPhone and Samsung Galaxy Note II, which have the capability of operating with a wired or wireless keyboard.

2. Description of Related Art

Portable electronic tablet devices are gaining increasing popularity in the market. They are typically larger than smartphones in size and smaller than laptop and desktop computers. The user typically interacts with the tablet device by using a finger, a stylus and/or a keyboard to input data or instructions to the device. Typically, tablet devices are carried by hand and moved about. However, most tablet devices generally do not include any type of protective case to protect the device from damage by external conditions or forces, which may result during their use or transport. It is desirable that protective covers and cases allow users to use the tablet and or keyboard without requiring removal of the protective cover or case. When accompanied with a keyboard, most existing tablet case solutions do not include the capability to protect the keyboard and/or prevent the depression of a key or keys on the keyboard when the user is using their tablet device when use of the keyboard is not desired or required or to allow the user to use the case as a stand for the tablet while being used with a keyboard.

Therefore, a need exists in the art for a folding tablet and keyboard cover which provides protection to the tablet and keyboard when not in use by the user, which provides an ergonomic, adjustable stand and stable platform for the user to position the tablet screen in proximity to the keyboard for use by the user, and which provides protection to the keyboard and prevents the depression of the keyboard keys while the tablet is being used without the aid or need of the keyboard. The invention disclosed herein satisfies such needs. Other technical advantages of the present invention will be readily apparent to one skilled in the art from and understanding of the following figures, descriptions and claims. While specific advantages and embodiments have been enumerated above, various embodiments may include all, some, or even none of these enumerated advantages.

### BRIEF SUMMARY OF THE INVENTION

The present invention includes a folding tablet keyboard case comprising a tablet cover having exterior and interior sides with rounded circumferential edges, a keyboard cover having exterior and interior sides cover with circumferential edges and, and a spine including at least one or more folding hinges, where the spine connects the tablet cover and the keyboard cover and wherein a portion of the spine comprises a portion of the keyboard cover. The tablet keyboard case provides for at least four general configurations that provide for a streamlined form factor in the open tablet position, closed tablet position, open keyboard position and tilted tablet position.

In one embodiment, one or more grooves are formed into the interior surface of the keyboard cover to provide multiple different viewing angle capability in the open keyboard position. In one embodiment, one or more fastening devices such as magnets, hooks, levees, posts, snaps, hook and loop material or other fastening apparatus are located about the keyboard cover and tablet cover so as to provide fastening capability for retaining the tablet case in the open tablet, open keyboard, tilted tablet or closed tablet position as described herein. The tablet keyboard case is operable as a stand in the open keyboard position allowing the user to position the keyboard and tablet in multiple configurations without the need to carry a separate stand.

In one embodiment, the present invention includes a folding tablet keyboard case which includes a folding tilt support which is deployed to orient the tablet cover at an acute angle relative to the keyboard cover allowing the user to adjust the viewing angle of the tablet in the open tablet position when the keyboard is not in use and remains in the keyboard cover. In one embodiment, one or more tilt support legs may be deployed to orient the tablet cover at an acute angle relative to the keyboard cover for adjusting the viewing angle of the tablet screen in the open tablet position when the keyboard is not in use and remains covered in the keyboard cover.

In one embodiment, the present invention teaches a folding tablet keyboard case includes, providing a tablet cover with exterior and interior sides with rounded peripheral edges, a keyboard cover with exterior and interior sides with rounded peripheral edges, a spine with at least one or more folding hinges which allows the user to fold the tablet cover and keyboard cover on to each other providing protection for the keyboard and tablet.

### BRIEF DESCRIPTION OF THE SEVERAL VIEWS OF THE DRAWING(S)

Various aspects of the invention, as well as an embodiment, are better understood by reference to the following detailed description. The detailed description, given by way of examples and not intended to limit the present invention solely thereto, will be better understood when read in conjunction with the drawings wherein like reference numerals denote like elements and parts in which:

FIGS. 1A-1C are various views of an embodiment of the tablet keyboard case invention shown in a closed tablet position as disclosed herein;

FIG. 2A is a side view of an embodiment of the tablet keyboard case invention shown in the open keyboard position as disclosed herein;

FIG. 2B is a rear perspective view of an embodiment of the tablet keyboard case invention shown in the open keyboard position as disclosed herein;

FIG. 2C is a front perspective view of an embodiment of the tablet keyboard case invention shown in the open keyboard position as disclosed herein;

FIGS. 3A-3B are side and perspective views, respectively, of an embodiment of the tablet keyboard case invention in the open tablet position as described herein;

FIGS. 4A-4B are side and perspective views, respectively, of an embodiment of the tablet keyboard case invention with integrated support stand in the tilted tablet position as described herein;

FIGS. 5A-5B are side and perspective view, respectively, of an embodiment of the tablet keyboard case invention with integrated support legs shown in the tilted tablet position as described herein; and,

FIGS. 6A-6B are various views of an embodiment of the tablet keyboard case invention shown in with the spine folded to support the tablet keyboard case in the tilted tablet position as described herein.

The above figures are provided for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

For purposes of teaching and discussion, it is useful to provide some overview as to the way in which the invention disclosed herein operates. The following information may be viewed as a basis from which the present invention may by properly explained. Such information is offered for purposes of explanation only and, accordingly, should not be construed to limit the broad scope of the present invention and its potential applications.

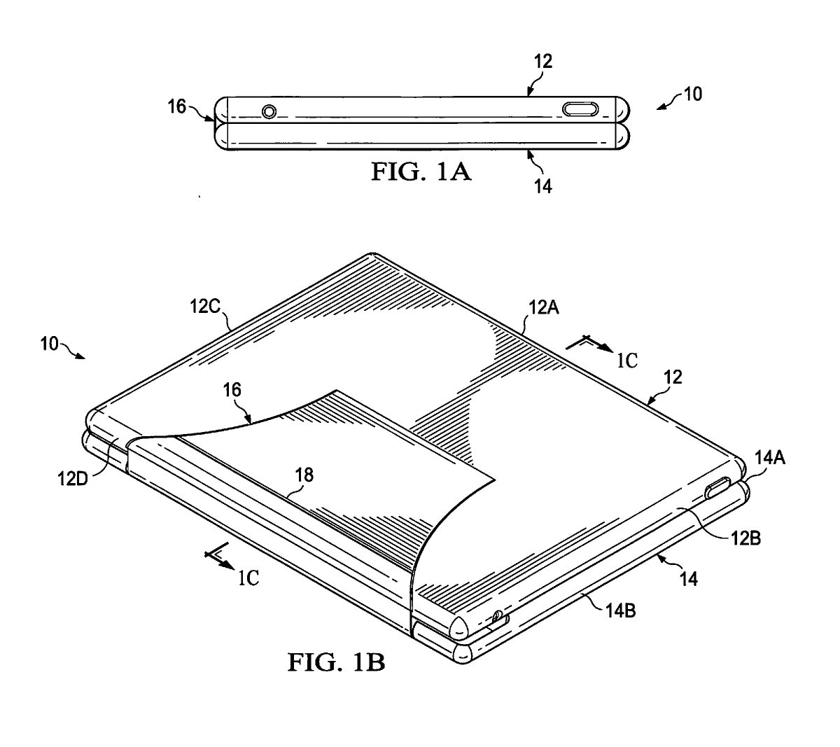

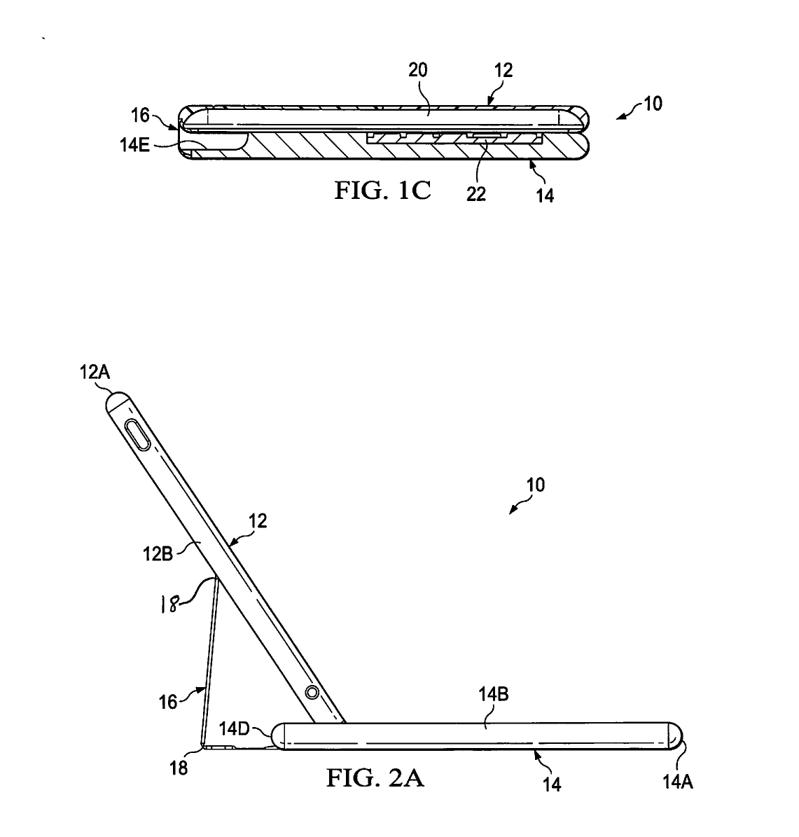

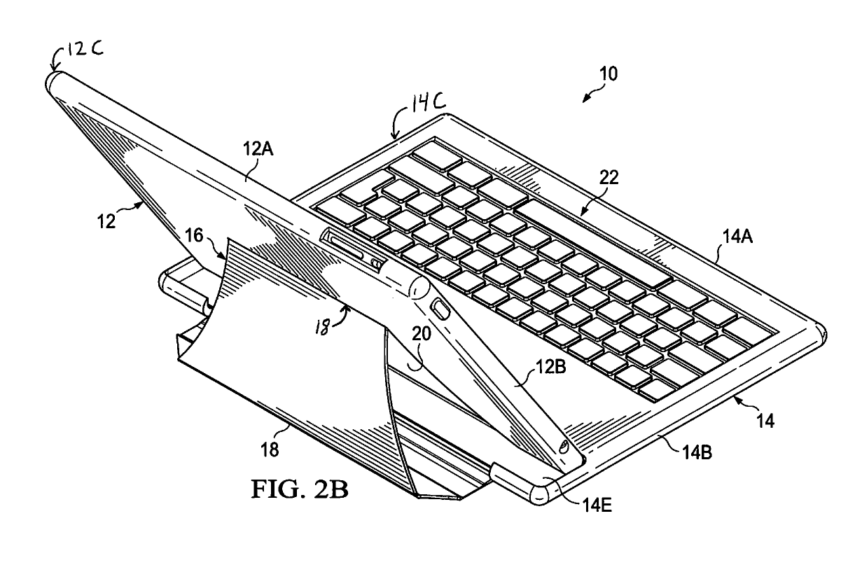

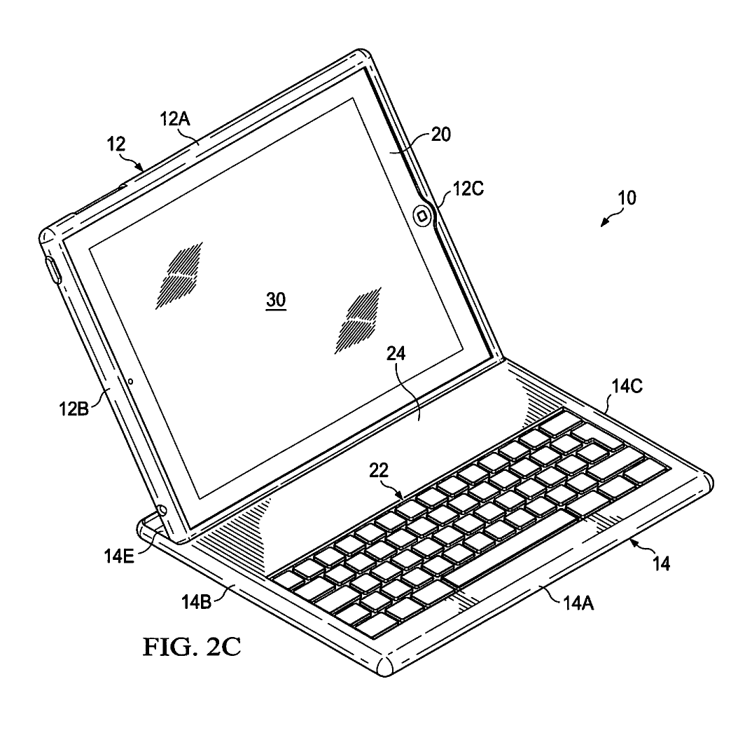

Turning to FIG. 1A, a side view of the tablet keyboard case 10 embodiment is shown in the closed tablet position. As described herein, the closed tablet position describes a position in which tablet cover 12 and keyboard cover 14 are folded over on to each other so that the keyboard and tablet devices enclosed in tablet keyboard case 10 face each other with the external surfaces of tablet cover 12 and keyboard cover 14 exposed to the outside environment. In this configuration, the external surfaces of the tablet cover 12 and keyboard cover 14 protect the tablet and keyboard from damage or shock. As shown, tablet edges 12A, 12B, 12C, 12D (as marked in FIGS. 2-5) are substantially aligned and concentrically oriented with keyboard cover edges 14A, 14B, 14C, 14D (as marked in FIGS. 2-5) and tablet cover 12 acts to cover and protect the keyboard surface secured within keyboard cover 14. Spine 16 is integrated as part of the tablet cover 12 exterior surface in the closed tablet position as shown. As depicted in FIGS. 1B, 1C, 2B, and 2C, tablet keyboard case 10 includes tablet cover 12 with tablet cover edges 12A, 12B, 12C, 12D, a keyboard cover 14 with keyboard cover edges 14A, 14B, 14C, 14D, a tablet, smartphone, or other electronic device 20 secured by tablet cover 12 and a keyboard secured by keyboard cover 14.

A perspective view of tablet keyboard case 10 is shown in the closed tablet position in FIG. 1B. In this view, a portion of spine 16 forms a corresponding portion of tablet cover 12 when the tablet keyboard case 10 is in the closed tablet position. Spine 16 includes at least one folding hinge 18 incorporated into spine 16 for adjustability of the tablet cover 12 relative to the keyboard cover 14 due to the folding nature of spine 16 via hinge 18 and as further described herein. In one embodiment, spine 16 is connected by hinge 18 on the exterior surface of tablet cover 12 (as shown in FIG. 2A). Spine 16 may be manufactured from flexible, stretchable, shrinkable materials such as metal, wood, nylon, neoprene, spandex, and/or layered, flexible metal bistable bands contained within a fabric or plastic covers, which allow the spine 16 to stretch, shrink, bend and/or flex to function and fit the different tablet keyboard case configurations described herein.

FIG. 1C shows a cross-section of the tablet keyboard cover 10 with a tablet or other electronic device 20 detachably secured with tablet cover 12, a keyboard 22 detachably secured with keyboard cover 14, and spine 16 which connects tablet cover 12 and keyboard cover 14. Groove 14E is shown which provides a friction or rest stop for an edge of tablet 20 or tablet cover edge 12D to rest in while the tablet keyboard cover 10 is placed in the open keyboard position which is explained in greater detail below. Groove 14E is generally parallel with keyboard edges 14A, 14D and generally extends the length of the keyboard cover 14 bounded by keyboard edges 14B, 14C. Keyboard 22 is secured within an area preformed into keyboard cover 14 as depicted. Tablet cover 12, keyboard cover 14, and groove 14E or multiple or a plurality of grooves 14E may be dimensioned to accommodate various sizes of electronic devices as known in the art.

With reference to FIG. 2A, a side view of tablet keyboard cover 10 in the open keyboard position is depicted. As described herein, the open keyboard configuration is the position in which the user desires to use a keyboard which is detachably secured in keyboard cover 14 to input information or otherwise operate a tablet detachably secured in tablet cover 12. In this position, the user adjusts tablet cover 12 by folding spine 16 via hinges 18 while keyboard cover 14 remains in a substantially horizontal position when placed upon a stable surface such as a desk or worktable. Additional hinges 18 may be incorporated into spine 16 to provide variable viewing angles resulting from the variable folded configurations of spine 16 provided by each section of spine 16 disposed between hinge(s) 18 for the tablet touchscreen while the user is utilizing the keyboard enclosed by keyboard cover 14. In this position, the user may input data, interact or otherwise operate tablet 20 by depressing or otherwise actuating the keys of keyboard 22. In the depicted embodiment, keyboard 22 communicates wirelessly with tablet 20 by a wireless protocol such as Bluetooth wireless technology. The Bluetooth wireless protocol is a short-range wireless communication system intended to replace cables connecting portable devices, such as a tablet and a keyboard, while maintaining data transfer security. Bluetooth and other known wireless communication methodologies are well known in the art. In similar fashion, a wire or cable (not shown) could also be used to establish a communication pathway between tablet 20 and keyboard 22 if a wired connection is desired.

FIG. 2B provides a rear perspective view of tablet keyboard cover 10 shown in the open keyboard position. In this position, tablet cover 12 is oriented at an angle relative to keyboard cover 14 and is maintained in this position by placing an edge, such as tablet cover edge 12D, in contact with an edge of the keyboard 22 or in a formed groove 14E which acts as a friction stop. In one embodiment, groove 14E may consist of multiple rows of grooves extending in a substantially parallel fashion and parallel to keyboard edges 14A, 14D providing the user with multiple grooves in which to rest tablet cover edge 12D in the open keyboard position. In one embodiment, one or more magnets or other fasteners may be incorporated into various locations along, within or on edges 12A, 12B, 12C, 12D of tablet cover 12 and edges 14A, 14B, 14C, 14D of keyboard cover 14 and groove 14E which may act to secure tablet cover 12 and keyboard cover 14 in various angular configurations to provide multiple, securely adjustable viewing positions at the desire of the user. In one embodiment, parallel notches may be formed into one or more edges 14B, 14C of keyboard cover 14 with corresponding extensions formed and protruding from one or more edges 12B, 12C in tablet cover 12 into which an edge of tablet cover 12 may be inserted to act as a friction stop and still provide multiple, securely adjustable viewing positions at the desire of the user.

Turning to FIG. 2C, a front perspective view of tablet keyboard cover 10 is shown in the open keyboard position. In this position, the user may utilize keyboard 22 that is secured in keyboard cover 14 for interacting with tablet 20 that is secured in tablet cover 12. Spine 16 acts to provide support for maintaining the viewing angle of tablet touchscreen 20 while the user utilizes keyboard 22 for inputting data and controlling the operation of tablet 20. The user may also use a finger, stylus or other input device for inputting data or otherwise controlling tablet 20 by touching touchscreen surface 30. In the depicted embodiment, keyboard 22 is detachably secured substantially within keyboard cover 14 with the top of the keyboard 22 substantially level and parallel with keyboard cover foreground 24. In various embodiments, keyboard foreground 24 may consist of a series of parallel grooves 14E which provide variable adjustability for positioning of the tablet viewing angle. In various embodiments, keyboard cover foreground 24 may consist of one or multiple component pieces that may be removed and sized to accommodate keyboard 22 of various dimensions and to provide variable viewing angles. For example, the selected viewing angle in the open keyboard position may range from about zero to ninety degrees, such as 30, 40, 50, 60, 70 and 80 degrees in various embodiments depending on the spacing and locations of grooves 14E or in another embodiment comprising the width of keyboard cover foreground 24.

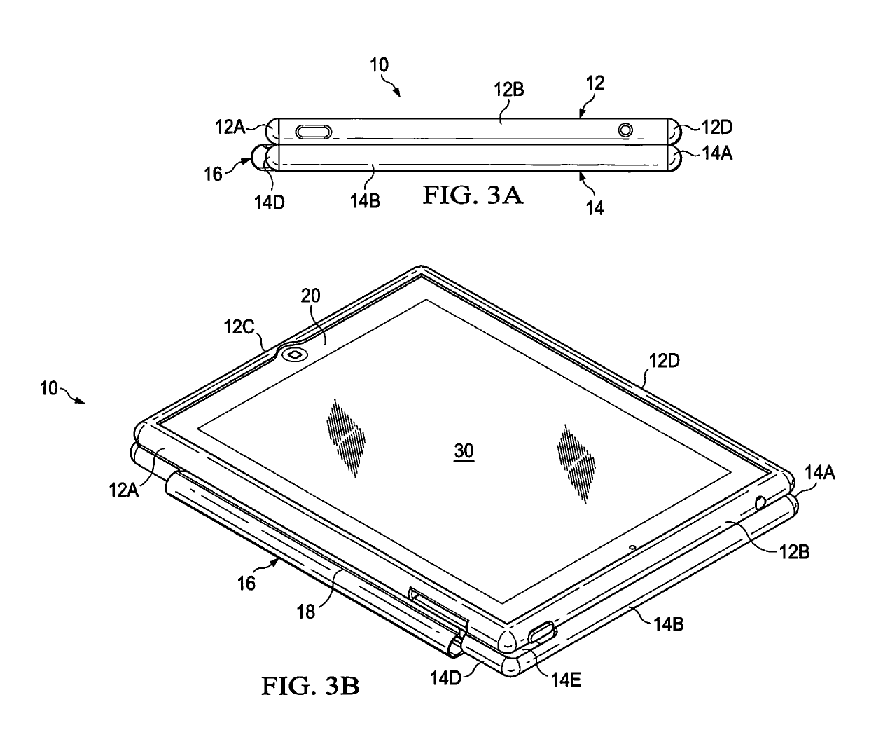

FIG. 3A depicts a side view of tablet keyboard case 10 that is shown in the open tablet position. In this position, the tablet cover 12 is rotated substantially 180 degrees at the point of hinged rotation where the spine 16 attaches to tablet cover 12 and tablet cover 12 is folded on to the keyboard cover 14 and acts to cover and protect the keyboard secured by keyboard cover 14. In the open tablet position, the user may operate the tablet by accessing the tablet touchscreen with a finger, stylus or other input device while keeping the keys on keyboard from being inadvertently depressed as the manipulates the tablet or while walking and carrying the tablet. In the open tablet position, tablet cover edges 12A, 12B, 12C, 12D are substantially parallel and concentric with keyboard cover edges 14A, 14B, 14C, 14D all of which are detachably secured by fasteners such as magnets, hook and loop, studs, snaps, hooks or other fasteners as known in the art. Spine 16 as folded may protrude (as shown) or may be constructed so as to fold or mold around keyboard cover edge 14D in symmetrical fashion.

FIG. 3B depicts a perspective view of tablet keyboard case 10 in the open tablet position. As shown, tablet edges 12A, 12B, 12C, 12D are substantially aligned and concentrically oriented with keyboard cover edges 14A, 14B, 14C, 14D and tablet cover 12 acts to cover and protect the keyboard surface secured within keyboard cover 14. In this configuration, the user may easily interface with tablet touchscreen 30 of tablet 20 that is secured with tablet cover 12. While interfacing with tablet touchscreen 30 on the surface of tablet 20, tablet cover 12 which is now detachably secured to keyboard cover 14 by releasable fasteners such as magnets, hook and loop material or snaps or other fasteners as known in the art and which maybe position along or within the tablet cover edges 12A, 12B, 12C, 12D and/or positioned along or within the keyboard cover edges 14A, 14B, 14C, 14D, to provide protection to the keyboard 22 secured by keyboard cover 14 and prevents the inadvertent depression of keys located on the keyboard 22. In this configuration, the tablet 20 is easily utilized by the user and easily transported while being carried by the user in the tablet keyboard case 10.

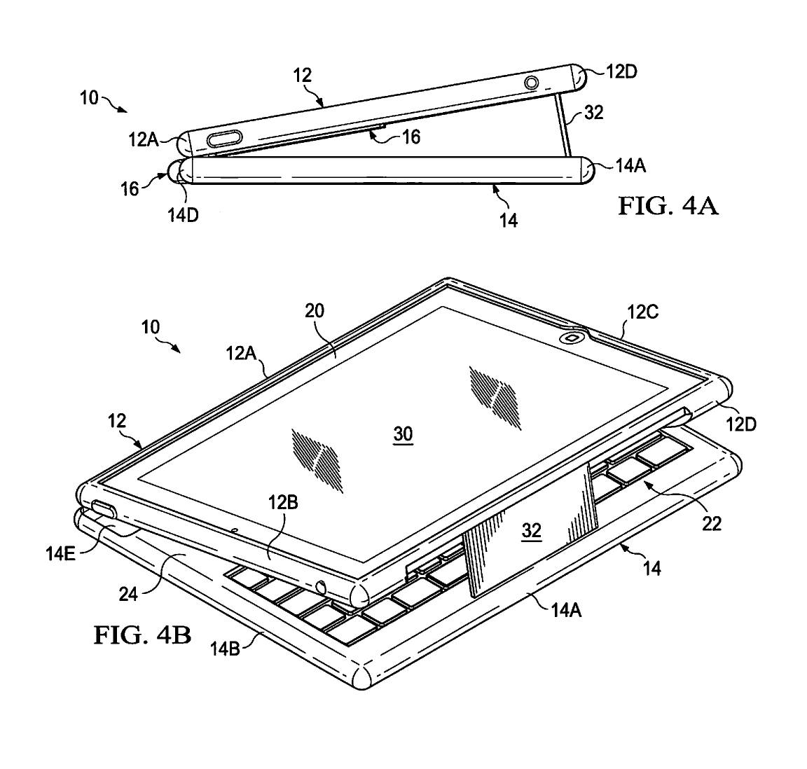

FIGS. 4A and 4B show one embodiment of the tablet keyboard case 10 which includes a tilt support 32 which acts to provide an adjustable viewing angle for the user while the tablet is in the tilted tablet position. In the depicted embodiment, tablet cover 12 is rotated in general fashion to the tilted tablet position. Instead of aligning concentrically and fastening tablet cover edges 12A, 12B, 12C, 12D with keyboard cover edges 14A, 14B, 14C, 14D, the user folds out tilt support 32 which is stored and integrated as a portion of tablet cover 12 allowing an edge of tilt support 32 to rest on keyboard 22 and/or against keyboard cover edge 14A as shown. In one embodiment, at least one groove (not shown) is integrated between keyboard 22 and keyboard cover edge 14A to act as a friction stop when tilt support 32 is placed in such groove or in another embodiment against keyboard cover edge 14A . Alternatively, multiple grooves could be integrated parallel to keyboard cover edge 14A to provide for a plurality of tilted viewing angles for the user. Alternatively, fasteners such as magnets, hook and loop material, levees, or peg and notch fasteners or such as is known in the art could be utilized to keep the tilt support 32 in the desired position. In this configuration, keyboard 22 is still substantially protected from inadvertent depression of keys located on keyboard 22 while the user uses, views content or otherwise interacts with tablet touchscreen 30 while using tablet 20.

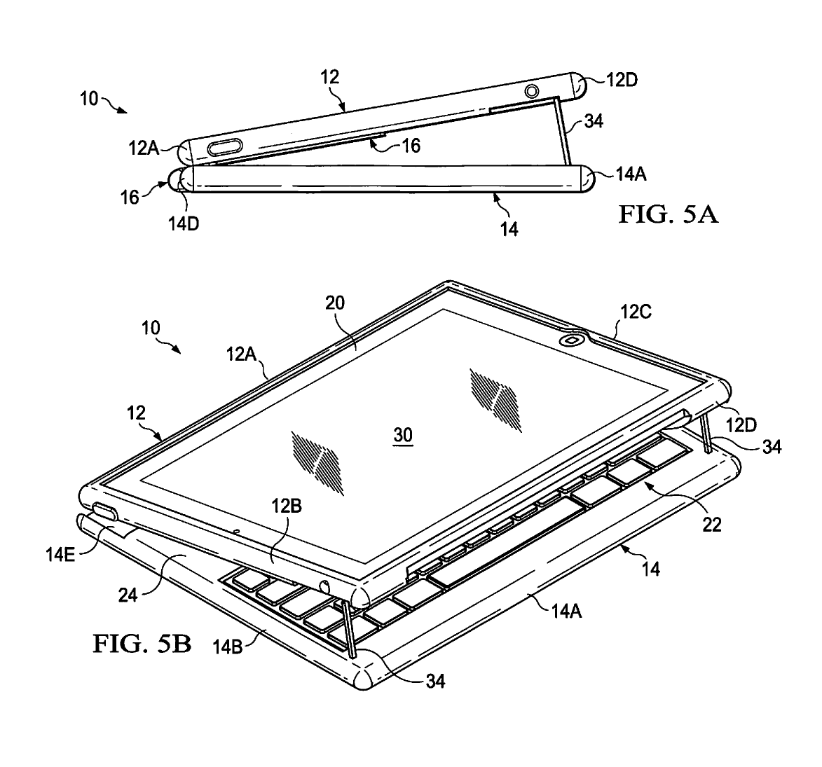

FIGS. 5A and 5B show one embodiment of the tablet keyboard case 10 which includes at least two tilt support legs 34 which act to provide an adjustable viewing angle for the user while the tablet is in the tilted tablet position. In the depicted embodiment, tablet cover 12 is rotated in general fashion to the tilted tablet position. Instead of aligning and fastening tablet cover edges 12A, 12B, 12C, 12D with keyboard cover edges 14A, 14B, 14C, 14D, the user folds out tilt support legs 34 which are stored and integrated as a portion of tablet cover 12 allowing the free ends of each tilt support leg 34 to rest on keyboard 22 and/or against keyboard cover edge 14A as shown. In one embodiment, at least one groove or notch (not shown) is formed between keyboard 22 and keyboard cover edge 14, or along edges 14A, 14B, 14C, 14D to act as a friction stop when tilt support legs 34 are placed in such groove or notch. Alternatively, multiple grooves or notches could be integrated between keyboard 22 and keyboard cover edge 14, or along edges 14A, 14B, 14C, 14D as discussed above to provide for a plurality of adjustable tilted viewing angles for the user. Alternatively, fasteners such as magnets, hooks, studs, snaps, levees, posts, hook and loop material, or peg and notch could be utilized along or within edges 14A, 14B, 14C, 14D to keep the tilt support legs 34 in the desired position. In this configuration, keyboard 22 is still substantially protected from inadvertent depression of keys located on keyboard 22 while the user uses, views content or otherwise interacts with tablet touchscreen 30 while using tablet 20.

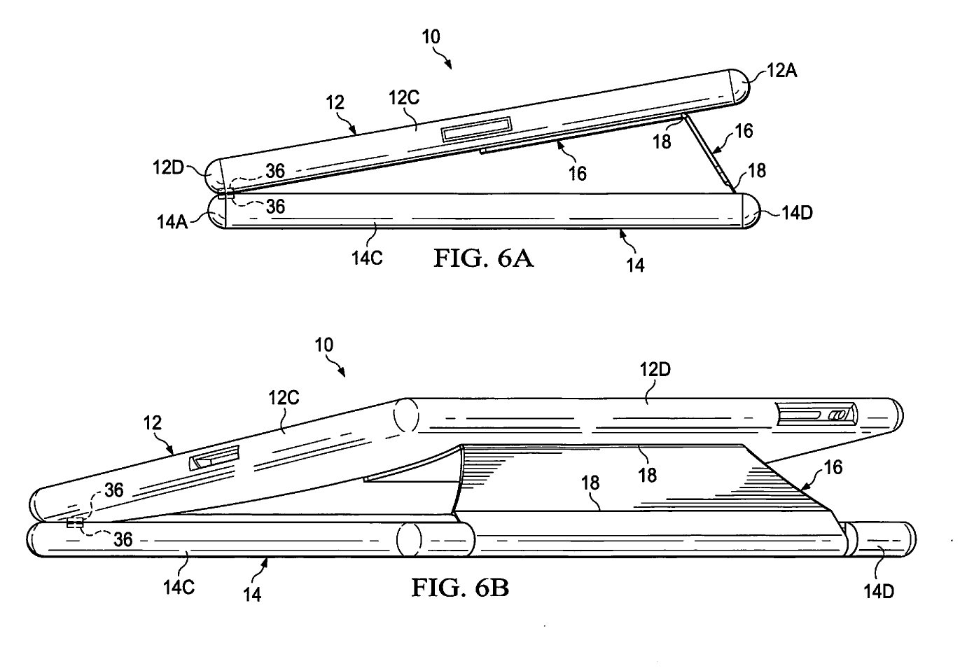

FIGS. 6A-6B depict one embodiment of the tablet keyboard case 10 that utilizes at least one reusable fastener for securing the tablet keyboard case 10 in a variety of positions, and in the instant figures, the tilted tablet position. It is noted that such fasteners could be integrated in a variety of locations around the periphery of tablet cover 12 and keyboard cover 14 along or within tablet cover edges 12A, 12B, 12C, 12D and keyboard cover edges 14A, 14B, 14C, 14D in positions to facilitate fastening the tablet keyboard case 10 into the open tablet position, closed tablet position and open keyboard position in similar manner. By way of example, folding and fastening the tablet keyboard cover 10 into the tilted tablet position is depicted in FIGS. 6A-6B. FIGS. 6A depicts fasteners 36 which have been integrated into tablet cover 12 and keyboard cover 14 in the corner peripheral region along tablet cover edge 12D and corresponding keyboard cover edge 14A. FIG. 6B demonstrates the folding hinges 18 included in spine 16 providing the user with the ability to tilt the tablet cover 12 at various multiple acute angle relative to the keyboard cover 14. As shown in FIG. 6A, the fasteners 36 are detachably mated to connect the tablet cover 12 and keyboard cover 14 together to form the desired viewing angle so the user may interact or otherwise operate the tablet secured with tablet cover 12 while preventing actuation or depression of the keys on they keyboard secured with keyboard cover 14.

FIG. 6B is a rear perspective view of tablet keyboard case 10 shown in the tilted tablet position with fasteners 36 shown detachably mated to maintain tablet keyboard case 10 in the tilted tablet position. When the user desires to alter the position of the tablet for viewing purposes or move the tablet keyboard case 10 into the open tablet, closed tablet, or open keyboard positions, they may simply pull the mated portions of tablet cover 12 and keyboard cover 14 apart, reposition them in the desired configuration and press tablet cover 12 and keyboard cover 14 in sufficient proximity so as to engage the particular fasteners 36. Fasteners 36 which may be utilized to perform the reusable fastener function may include magnets, hook and loop material and snap fasteners among others as known in the art and as described elsewhere herein.

The invention disclosed herein may be manufactured from various plastics, woods, carbon fiber, leather and metals. For example, the tablet cover and keyboard cover may be manufactured from polycarbonate, plastics, metals, rubber or soft polymers such as silicone. Other examples include thermoplastic, polyvinyl chloride, synthetic leather, leatherette, and carbon fiber. A touchscreen protector may also be incorporated to provide protection to the exposed touchscreen surface. The tablet cover case would also incorporate various openings and slots at various locations to allow the user to access the tablet control buttons, switches and connector ports. The tablet and keyboard covers would likewise be shaped to securely hold tablet and keyboard devices. For example, the tablet and keyboard covers may be contained within a pliable hard or soft shell designed to form a moldable, snug fit around the tablet and keyboard. Alternatively, the tablet and keyboard covers may include a snap flap along one or more edges to allow a user to open the flap and insert the keyboard and/or tablet into their respective covers and then snap the flap shut to provide secure retention of the keyboard and tablet in their respective covers.

The spine may include both rigid and pliable materials manufactured in sections so as to hinge as described herein. The spine may incorporate metal, wood, carbon fiber, thermoplastic or hard plastics that are stitched or incorporated into a flexible or semi-flexible covering such as cloth, microfiber, plastic, and leather among others, providing a rigid or semi-rigid spine as desired with one or more hinged sections. In certain implementations, the hinge or hinges show as crease lines where the material (e.g. leather, plastic or fabric) at the crease line can be flexed, allowing the flaps or panels of the spine to swing or rotate with respect to each other. Other hinges and techniques may not result in crease lines in the material forming or covering the spine. These hinges may be referred to as hidden or invisible hinges. Whether shown or invisible, hinges which may used in connection with the invention include swing hinges, living hinges, flush hinges, piano hinges, continuous hinges, concealed hinges, and spring hinges among others as known in the art. The hinge or hinges may be made from various materials including leather, microfiber, plastic, metal, rubber, silicone, carbon fiber and other materials as known in the art.

It should also be noted that the tablet keyboard case described and shown herein could easily be sized and manufactured for electronic devices of various sizes and shapes including computers, laptop computers, tablet computers, tablets, smartphones, personal digital assistant (PDA) devices, music storage and listening devices such as the iPod and iPod Touch and other such devices produced by other manufacturers. As such, the description and claims herein are not to be construed as limited to certain types or dimensions of phones, computers, laptops, tablets, keyboards or other electronic devices.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. While various alterations and permutations of the invention are possible, the invention is to be limited only by the following claims and equivalents.

I claim:

1. A folding case for an electronic device comprising:
a tablet cover with at least four rounded circumferential edges;
a keyboard cover with at least four rounded circumferential edges; and,
a spine with at least two hinges wherein said spine forms a portion of the exterior of the tablet cover and connects the tablet cover and keyboard cover for rotating the tablet cover and keyboard cover from a closed tablet position to an open tablet position wherein the exterior surface of the tablet cover substantially covers the keyboard secured within the keyboard cover and the tablet cover edges are substantially concentrically aligned with the opposing keyboard cover edges.

2. The case of claim 1 further comprising:
at least one fastener integrated into at least one edge of the tablet cover and at least one fastener integrated into an opposing corresponding edge of the keyboard cover which act to detachably secure the keyboard cover and the tablet cover.

3. The case of claim 1 further wherein the fastener is chosen from the group consisting of hook-and-loop material, molded tongue and grooves, slot, snap, levee, post, and magnets.

4. The case of claim 1 wherein the keyboard cover and tablet cover are manufactured from materials selected from the group consisting of a metals, plastics, thermoplastics, carbon fiber, wood and leather.

5. The case of claim 1 wherein the spine is manufactured from materials selected from the group consisting of metals, plastics, thermoplastics, carbon fiber, wood, leather and bistable metals and plastics.

6. A folding case for an electronic device comprising:
a tablet cover with at least four rounded circumferential edges;
a keyboard cover with at least four rounded circumferential edges; and, a spine with at least two hinges wherein said spine forms a portion of the exterior of the tablet cover and connects the tablet cover and keyboard cover for rotating the tablet cover and keyboard cover from a closed tablet position to a tilted tablet position and which provides support for the tablet cover in the tilted tablet position.

7. The case of claim 6 further comprising:
a folding tilt support integrated within and hingedly connected to the tablet cover wherein the tilt support is folded out of the tablet cover and placed in contact with an opposing keyboard cover edge or keyboard cover edge and supports the tablet cover at an acute tilt angle relative to the keyboard cover.

8. The case of claim 7 further wherein the folding tilt support comprises at least one tilt support leg.

9. The case of claim 6 further comprising:
at least one fastener integrated into at least one edge of the tablet cover and at least one fastener integrated into a corresponding edge of the keyboard cover which act to detachably secure the keyboard cover and the tablet cover in the tilted tablet position.

10. The case of claim 9 wherein the fastener is selected from the group consisting of hook-and-loop material, molded tongue and grooves, slot, snap, levee, post, and magnets.

11. A folding case for an electronic device comprising:
a tablet cover with at least four rounded circumferential edges;
a keyboard cover with at least four rounded circumferential edges;
a spine with at least two hinges wherein said spine forms a portion of the exterior of the tablet cover and connects the tablet cover and keyboard cover for rotating the tablet cover and keyboard cover from a closed tablet position to an open keyboard position; and,
a groove integrated with the keyboard cover wherein the groove is substantially parallel to an edge of a keyboard secured in the keyboard cover wherein an edge of the tablet cover is inserted into the groove to retain the tablet keyboard cover in the open keyboard position.

12. The case of claim 11 further comprising:
at least one fastener integrated into at least one edge of the tablet cover and at least one fastener integrated into an opposing corresponding edge of the keyboard cover which act to detachably secure the keyboard cover and the tablet cover.

13. The case of claim 11 wherein the fastener is selected from the group consisting of hook-and-loop material, molded tongue and grooves, slot, snap, levee, post, and magnets.

14. The case of claim 11 wherein the groove is formed by the top edge of the keyboard and the interior portion of the tablet cover.

15. The case of claim 11 wherein a plurality of grooves are integrated with the keyboard cover wherein the plurality of grooves are substantially parallel to an edge of a keyboard secured in the keyboard cover wherein an edge of the tablet cover is inserted into one of the plurality of grooves in the tablet keyboard cover to provide an adjustable viewing angle.
